(19) United States
(12) Patent Application Publication
(10) Pub. No.: US 2016/0125558 A1
(43) Pub. Date: May 5, 2016

(54) RESTAURANT COMMUNICATION ASSEMBLY

(71) Applicant: Walter Clyburn, Vauxhall, NJ (US)

(72) Inventor: Walter Clyburn, Vauxhall, NJ (US)

(21) Appl. No.: 14/528,067

(22) Filed: Oct. 30, 2014

(51) Int. Cl. G06Q 50/12; G06Q 30/06; G06Q 30/02

(52) U.S. Cl. CPC G06Q 50/12; G06Q 30/0281; G06Q 30/0643

(57) ABSTRACT

A restaurant communication assembly includes a plurality of base units each positioned proximate an associated one of a plurality of tables in a restaurant. Each of the base units stores a food menu. A respective base display is coupled to an associated one of the base units. The base display displays the food menu. Thus, the base display allows a user to order a selection from the food menu. A remote unit is positioned in a kitchen of the restaurant. The remote unit is in communication with the base units to receive the user's order. A remote display is coupled to the remote unit. The remote display displays the user's order. Thus, the display communicates the user's order to a cook. Each of plurality of mobile units is carried by an associated one of a plurality of waitresses in the restaurant. is in communication with the base unit to receive the user's order. The mobile unit is in communication with the remote unit such that the mobile units inform the waitresses when a respective user's order is complete.

### BACKGROUND OF THE DISCLOSURE

### Field of the Disclosure

The disclosure relates to devices and more particularly pertains to a new device for placing a user, a waitress and a cook in real time communication in a restaurant setting.

### SUMMARY OF THE DISCLOSURE

An embodiment of the disclosure meets the needs presented above by generally comprising a plurality of base units each positioned proximate an associated one of a plurality of tables in a restaurant. Each of the base units comprises a respective base processor, a respective electronic memory, a respective base transceiver and a respective base display. The electronic memory is electrically coupled to the base processor. The electronic memory stores a food menu. The base transceiver is in electrical communication with the base processor. The base display is electrically coupled to the base processor to display the food menu. Thus, the base display allows a user to order a selection from the food menu. A remote unit is positioned in a kitchen of the restaurant. A remote processor is coupled to the remote unit. A remote transceiver is coupled to the remote unit. The remote transceiver is electrically coupled to the remote processor. The remote transceiver is in communication with the base transceiver to receive the user's order. A remote display is coupled to the remote unit. The remote display is electrically coupled to the remote processor to display the user's order. Thus, the display communicates the user's order to a cook. Each of plurality of mobile units is carried by an associated one of a plurality of waitresses in the restaurant. Each of the mobile units comprises a respective mobile processor coupled to an associated one of the mobile units. A respective mobile transceiver is coupled to an associated one of the mobile units. The mobile transceiver is electrically coupled to the mobile processor. The mobile transceiver is in communication with the base transceiver to receive the user's order. The mobile transceiver is in communication with the remote transceiver such that the mobile units inform the waitresses when a respective user's order is complete. A respective mobile display is coupled to an associated one of the mobile units. The mobile display is electrically coupled to the mobile processor to displays the user's order.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an in-use view of a restaurant communication assembly according to an embodiment of the disclosure.

FIG. 2 is a front view of an embodiment of the disclosure.

FIG. 3 is a back view of an embodiment of the disclosure.

FIG. 4 is a front perspective view of an embodiment of the disclosure.

FIG. 5 is a perspective view of an embodiment of the disclosure.

FIG. 6 is a schematic view of an embodiment of the disclosure.

### DESCRIPTION OF THE PREFERRED EMBODIMENT

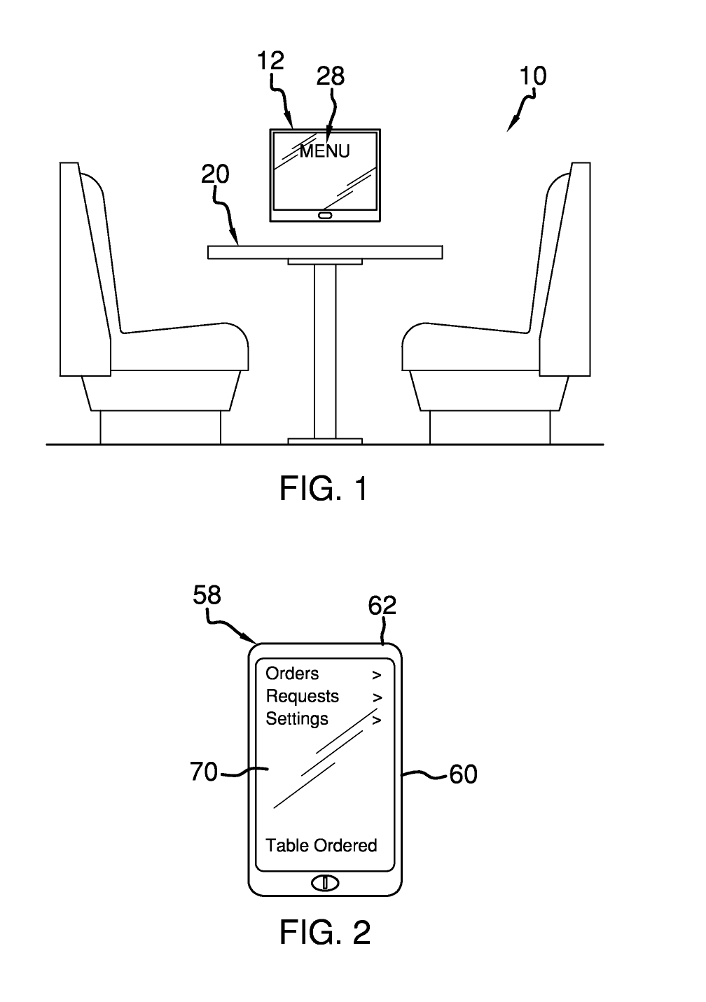

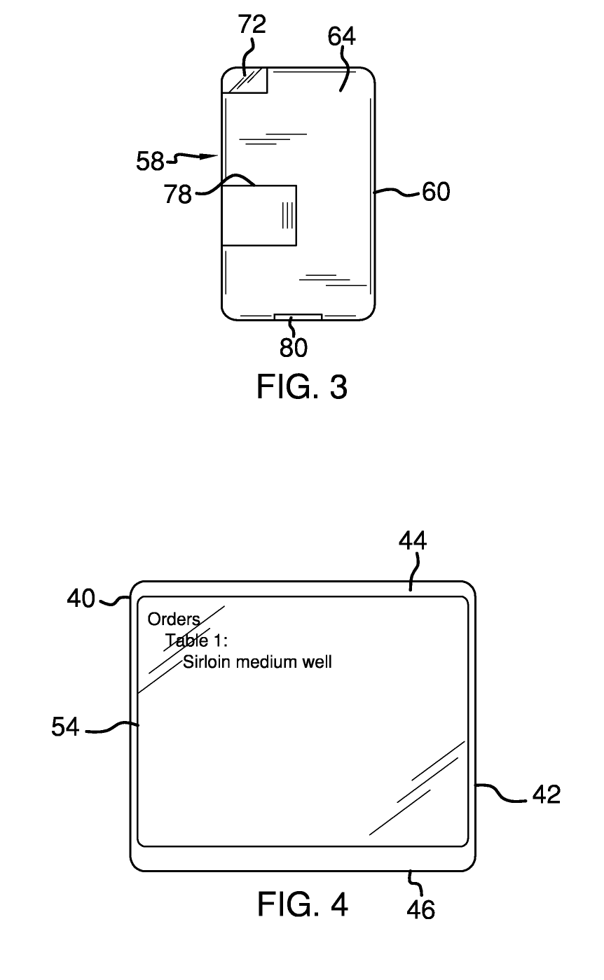

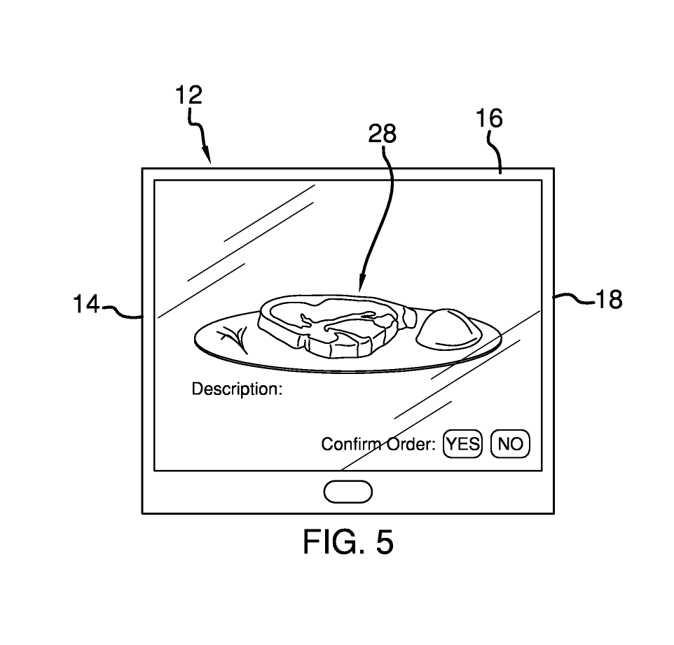

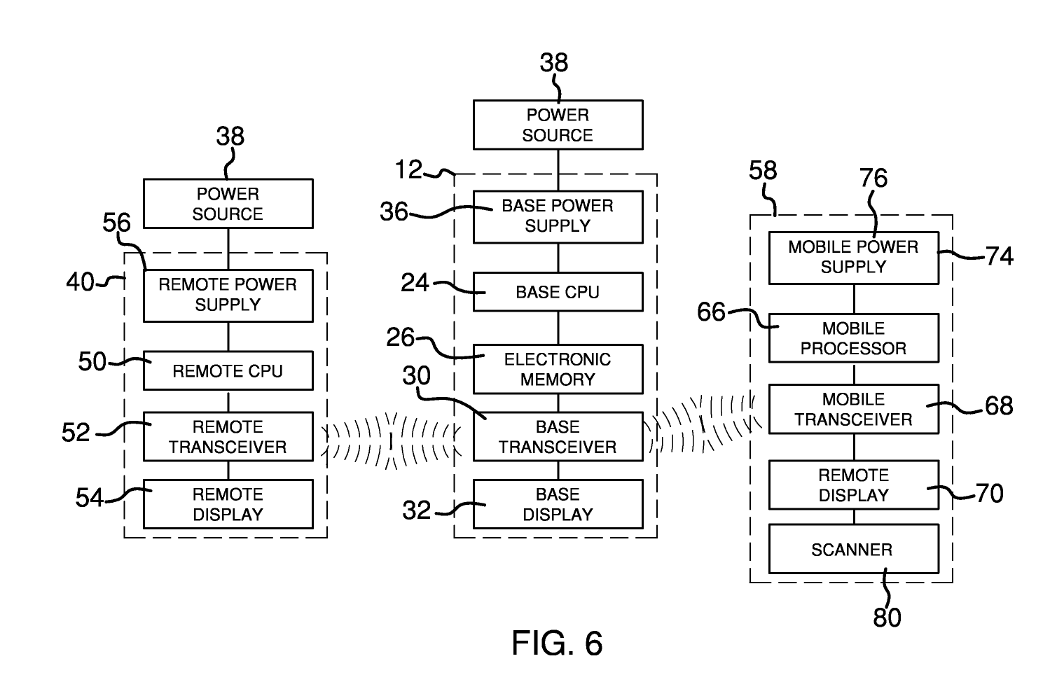

With reference now to the drawings, and in particular to FIGS. 1 through 6 thereof, a new device embodying the principles and concepts of an embodiment of the disclosure and generally designated by the reference numeral 10 will be described.

As best illustrated in FIGS. 1 through 6, the restaurant communication assembly 10 generally comprises each of a plurality of base units 12 having an outer wall 14 extending between a front side 16 and a back side 18 of the base units 12. Each of the base units 12 is positioned proximate an associated one of a plurality of tables 20 in a restaurant. Additionally, each of the base units 12 comprises a respective base processor 24 coupled to an associated one of the base units 12. A respective electronic memory 26 is coupled to an associated one of the base units 12. The electronic memory 26 is electrically coupled to the base processor 24. The electronic memory 26 stores a food menu 28.

A respective base transceiver 30 is coupled to an associated one of the base units 12. The base transceiver 30 is in electrical communication with the base processor 24. The base transceiver 30 may be an RF transceiver or the like. Additionally, the base transceiver 30 may utilize a WPAN signal.

A respective base display 32 is coupled to the front side 16 of an associated one of the base units 12. The base display 32 is electrically coupled to the base processor 24 such that the base display 32 displays the food menu 28 allowing a user to order a selection from the food menu 28. The base display 32 may be a touch screen display or the like.

A respective base power supply 36 is coupled to an associated one of the base units 12. The base power supply 36 is electrically coupled to the base processor 24. The base power supply 36 is electrically coupled to a power source 38. The power source 38 may be an electrical outlet or the like.

A remote unit 40 is provided. The remote unit 40 has an exterior wall 42 extending between each of a forward side 44 and a rearward side 46 of the remote unit 40. The remote unit 40 may be positioned in a kitchen of the restaurant 22. A remote processor 50 is coupled to the remote unit. A remote transceiver 52 is coupled to the remote unit 40. The remote transceiver 52 is electrically coupled to the remote processor 50. The remote transceiver 52 is in communication with each of the respective base transceivers 30 to receive the user's orders.

A remote display 54 is coupled to the forward side 44 of the remote unit 40. The remote display 54 is electrically coupled to the remote processor 50 to display the user's order. Thus, the remote display 54 communicates the user's order to a cook. The remote display 54 may be a touch screen display or the like.

A remote power supply 56 is coupled to the remote unit 40. The remote power supply 56 is electrically coupled to the remote processor 50. The remote power supply 56 is electrically coupled to a power source 38. Moreover, the power source 38 may be an electrical outlet or the like.

Each of plurality of mobile units 58 has an outermost edge 60 extending between each of a frontmost side 62 and a rearmost side 64 of the mobile units 58. Each of the mobile units 58 is carried by an associated one of a plurality of waitresses in the restaurant. Each of the mobile units 58 comprises a respective mobile processor 66 coupled to an associated one of the mobile units 58. A respective mobile transceiver 68 is coupled to an associated one of the mobile units 58. The mobile transceiver 68 is electrically coupled to the mobile processor 66.

The respective mobile transceiver 68 is placed into electromagnetic communication with a selected number of the respective base transceivers 30. Thus, each of the waitresses is informed of the ordering activities of each of the associated tables 20. The mobile transceiver 68 is in communication with the remote transceiver 52 to inform the waitresses when a respective user's order is complete. The mobile transceiver 68 may be an RF transceiver or the like. Additionally, the mobile transceiver 68 may utilize a WPAN signal.

A respective mobile display 70 is coupled to the frontmost side 62 of an associated one of the mobile units 58. The mobile display 70 is electrically coupled to the mobile processor 66 to display the respective user's orders. A respective scanner 72 is coupled to the rearmost side 64 of an associated one of the mobile units 58. The scanner 72 is electrically coupled to the mobile processor 66. The scanner 72 may scan an electronic means of payment provided by the user.

A respective mobile power supply 74 is coupled to the rearmost side 64 of an associated one of the mobile units 58. The mobile power supply 74 is electrically coupled to the mobile processor 66. The mobile power supply 74 comprises at least one battery 76. A respective battery cover 78 is removably coupled to the rearmost side 64 of the associated one of the mobile units 58. The mobile power supply 74 is positioned beneath the battery cover 78.

A respective charge port 80 is coupled to the outermost edge 60 of an associated one of the mobile units 58. The charge port 80 is electrically coupled to the mobile power supply 74. The charge port 80 may be electrically coupled to a power source 38 to charge the mobile power supply 74. The power source 38 may be a charger or the like.

In use, the user utilizes the respective base display 32 to order from the food menu. Each of the remote unit 40 and the associated one of the mobile units 58 is notified of the user's selection from the food menu. The selection from the food menu may include a food item, a desired degree of cooking of the food item, drinks and other selections related to ordering a meal in the restaurant. The assembly 10 provides real time communication between the user, the waitress and the cook. Additionally, the assembly 10 allows the user to make changes or additions to the user's selection of the food menu without the need to wait for the waitress.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A restaurant communication assembly comprising:
a plurality of base units, each of a said base units being configured to be positioned proximate an associated one of plurality of tables in a restaurant, each of said base units comprising
a respective base processor,
a respective electronic memory, said electronic memory being electrically coupled to said base processor, said electronic memory storing a food menu,
a respective base transceiver, said base transceiver being in electrical communication with said base processor, and
a respective base display, said base display being electrically coupled to said base processor such that said base display displays the food menu wherein said b base display is configured to allow a user to order a selection from the food menu;
a remote unit configured to be positioned in a kitchen of the restaurant;
a remote processor coupled to said remote unit;
a remote transceiver coupled to said remote unit, said remote transceiver being electrically coupled to said remote processor, said remote transceiver being in communication with said base transceiver wherein said remote processor receives the user's order;
a remote display coupled to said remote unit, said remote display being electrically coupled to said remote processor wherein said remote display displays the user's order wherein said display is configured to communicate the user's order to a cook;
each of plurality of mobile units configured to be carried by an associated one of a plurality of waitresses in the restaurant, each of said mobile units comprising
a respective mobile processor coupled to an associated one of said mobile units,
a respective mobile transceiver coupled to associated one of said mobile units, said mobile transceiver being electrically coupled to said mobile processor, said mobile transceiver being in communication with said base transceiver wherein said mobile processor receives the user's order, said mobile transceiver being in communication with said remote transceiver such that said mobile units are configured to inform the waitresses when a respective user's order is complete, and
a respective mobile display coupled to associated one of said mobile units, said mobile display being electrically coupled to said mobile processor wherein said mobile display displays the user's order.

2. The assembly according to claim 1, wherein said respective mobile transceiver being placed into electromagnetic communication with a selected number of said respective base transceivers wherein each of the waitresses are informed of the ordering activities of each of the associated tables.

3. The assembly according to claim 1, further comprising a respective base power supply coupled to an associated one of said base units, said base power supply being electrically coupled to said base processor, said base power supply being electrically coupled to a power source.

4. The assembly according to claim 1, further comprising a remote power supply coupled to said remote unit, said remote power supply being electrically coupled to said remote processor, said remote power supply being electrically coupled to a power source.

5. The assembly according to claim 1, further comprising a respective scanner coupled to an associated one of said mobile units, said scanner being electrically coupled to said mobile processor.

6. The assembly according to claim 1, further comprising a respective mobile power supply coupled to an associated one of said mobile units, said mobile power supply being electrically coupled to said mobile processor, said mobile power supply comprising at least one battery.

7. A restaurant communication assembly comprising:
each of a plurality of base units configured to be positioned proximate an associated one of plurality of tables in a restaurant, each of said base units comprising
a respective base processor,
a respective electronic memory, said electronic memory being electrically coupled to said base processor, said electronic memory storing a food menu,
a respective base transceiver, said base transceiver being in electrical communication with said base processor,
a respective base display, said display being electrically coupled to said base processor such that said display displays the food menu wherein said display is configured to allow a user to order a selection from the food item, and
a respective base power supply, said base power supply being electrically coupled to said base processor, said base power supply being electrically coupled to a power source;
a remote unit configured to be positioned in a kitchen of the restaurant;
a remote processor coupled to said remote unit;
a remote transceiver coupled to said remote unit, said remote transceiver being electrically coupled to said remote processor, said remote transceiver being in communication with said base transceiver wherein said remote processor receives the user's order;
a remote display coupled to said remote unit, said remote display being electrically coupled to said remote processor wherein said remote display displays the user's order wherein said display is configured to communicate the user's order to a cook;
a remote power supply coupled to said remote unit, said remote power supply being electrically coupled to said remote processor, said remote power supply being electrically coupled to a power source;
each of plurality of mobile units configured to be carried by an associated one of a plurality of waitresses in the restaurant, each of said mobile units comprising
a respective mobile processor coupled to an associated one of said mobile units,
a respective mobile transceiver coupled to associated one of said mobile units, said mobile transceiver being electrically coupled to said mobile processor, said respective mobile transceiver being placed into electromagnetic communication with a selected number of said respective base transceivers wherein each of the waitresses are informed of the ordering activities of each of the associated tables, said mobile transceiver being in communication with said remote transceiver such that said mobile units are configured to inform the waitresses when a respective user's order is complete,
a respective mobile display coupled to associated one of said mobile units, said mobile display being electrically coupled to said mobile processor wherein said mobile display displays the user's order,
a respective scanner coupled to an associated one of said mobile units, said scanner being electrically coupled to said mobile processor, and
a respective mobile power supply coupled to an associated one of said mobile units, said mobile power supply being electrically coupled to said mobile processor, said mobile power supply comprising at least one battery.
